(19) United States
(12) Patent Application Publication
(10) Pub. No.: US 2016/0350050 A1
(43) Pub. Date: Dec. 1, 2016

(54) INFORMATION PROCESSING APPARATUS, OPERATION SCREEN DISPLAY METHOD, AND COMPUTER-READABLE RECORDING MEDIUM

(71) Applicant: SEIKO EPSON CORPORATION, Tokyo (JP)

(72) Inventors: Yoshiyuki KANAMORI, Sapporo-Shi (JP); Mitsunori TOMONO, Suwa-Gun (JP); Makoto SHIGEMITSU, Sapporo-Shi (JP)

(73) Assignee: SEIKO EPSON CORPORATION, Tokyo (JP)

(21) Appl. No.: 15/161,886

(22) Filed: May 23, 2016

(30) Foreign Application Priority Data
May 29, 2015 (JP) 2015-109840

(51) Int. Cl. G06F 3/14

(52) U.S. Cl. CPC G06F 3/1423

(57) ABSTRACT

An information processing apparatus includes: a display section displaying an operation screen for operating a display apparatus; a function information reception section receiving function information indicating a function of the display apparatus from the display apparatus; an operation screen information reception section receiving operation screen information for operating the display apparatus; a storage section storing common operation screen information for operating the display apparatus; and a display control section causing the display section to display an operation screen according to the operation screen information received by the operation screen information reception section in a case in which the function information includes a function of supplying the operation screen information, and causing the display section to display an operation screen according to first common operation screen information stored in the storage section in a case in which the function information includes no function of supplying the operation screen information.

### CROSS-REFERENCE

The entire disclosure of Japanese Patent Application No. 2015-109840, filed May 29, 2015 is expressly incorporated by reference herein.

### BACKGROUND

1. Technical Field

The present invention relates to a technology for operating an electronic apparatus from another apparatus.

2. Related Art

As an invention for manipulating an electronic apparatus by using a portable terminal, for example, there is a portable terminal disclosed in JP-A-2012-253716. When a TV viewing application starts up in the portable terminal and the portable terminal is connected to a wireless LAN, the portable terminal displays a remote control screen on a touch panel. By operating the remote control screen displayed on the touch panel, a recorded program stored in a server can be reproduced or a channel can be selected in a television receiver.

For example, in a case in which a television receiver is replaced and a newly purchased television receiver has a new function which an apparatus of the related art does not have. However, in a case in which a remote control screen is operated on a new function, the version of a TV viewing application corresponding to the new function is updated and a user has to install the application with the upgraded version, and thus, it takes some time.

### SUMMARY

An advantage of some aspects of the invention is to provide a technology for displaying an operation screen corresponding to a display apparatus to be operated.

An aspect of the invention provides an information processing apparatus including: a communication section that is connected to a display apparatus to perform communication; a display section that displays an operation screen for operating the display apparatus; a function information reception section that receives function information indicating a function of the display apparatus from the display apparatus through the communication section; an operation screen information reception section that receives operation screen information for operating the display apparatus from the display apparatus through the communication section; a storage section that stores common operation screen information for operating the display apparatus; and a display control section that causes the display section to display an operation screen according to the operation screen information received by the operation screen information reception section in a case in which the function information includes a function of supplying the operation screen information, and causes the display section to display an operation screen according to first common operation screen information stored in the storage section in a case in which the function information includes no function of supplying the operation screen information.

In the information processing apparatus, it is possible to display the operation screen corresponding to a display apparatus which is an operation target.

According to the aspect of the invention, the display control section may further display an operation screen based on second common operation screen information which is stored by the storage section and is information for an operation common to a plurality of display apparatuses in the case in which the function information includes the function of supplying the operation screen information.

In such a configuration, it is possible to perform a common operation to a plurality of display apparatuses.

According to the aspect of the invention, the second common operation screen information may include information regarding an operation of changing a connection destination of the communication section.

In such a configuration, it is possible to easily change the display apparatus which is a connection destination and it is possible to change the display apparatus which is an operation target.

According to the aspect of the invention, the second common operation screen information may include information regarding an operation of changing content displayed by the display apparatus to which the communication section is connected.

In such a configuration, it is possible to easily change content to be displayed by the display apparatus which is a connection destination.

According to the aspect of the invention, the operation screen information reception section may receive operation screen information with a size according to a size of an operation screen displayed based on the second common operation screen information.

In such a configuration, it is possible to change the operation screen to be proper for the size of the common operation screen.

Another aspect of the invention provides an operation screen display method including: receiving function information indicating a function of a display apparatus from the display apparatus to which a communication section connected to the display apparatus to perform communication is connected; and causing a display section to display an operation screen according to operation screen information acquired from the display apparatus to which the communication section is connected in a case in which the function information includes a function of supplying the operation screen information for operating the display apparatus, and causing the display section to display an operation screen according to first common operation screen information stored in advance to operate the display apparatus in a case in which the function information includes no function of supplying the operation screen.

In the operation screen display method, it is possible to display the operation screen corresponding to a display apparatus which is an operation target.

Still another aspect of the invention provides a computer-readable recording medium storing a program. The program causes a computer to function as: a communication section that is connected to a display apparatus to perform communication; a display section that displays an operation screen for operating the display apparatus; a function information reception section that receives function information indicating a function of the display apparatus from the display apparatus through the communication section; an operation screen information reception section that receives operation screen information for operating the display apparatus from the display apparatus through the communication section; a storage section that stores common operation screen information for operating the display apparatus; and a display control section that causes the display section to display an operation screen according to the operation screen information received by the operation screen information reception section in a case in which the function information includes a function of supplying the operation screen information, and causes the display section to display an operation screen according to first common operation screen information stored in the storage section in a case in which the function information includes no function of supplying the operation screen information.

In the recording medium, it is possible to display the operation screen corresponding to a display apparatus which is an operation target.

### BRIEF DESCRIPTION OF THE DRAWINGS

The invention will be described with reference to the accompanying drawings, wherein like numbers reference like elements.

FIG. 1 is a diagram illustrating an apparatus related to a display system according to an embodiment of the invention.

FIG. 2 is a diagram illustrating a hardware configuration of a projector.

FIG. 3 is a functional block diagram illustrating a function realized in the projector.

FIG. 4 is a diagram illustrating a hardware configuration of an information processing apparatus.

FIG. 5 is a functional block diagram illustrating a function realized in the information processing apparatus.

FIG. 6 is a sequence diagram illustrating an operation example according to an embodiment.

FIG. 7 is a diagram illustrating an example of a screen displayed by the information processing apparatus.

FIG. 8 is a diagram illustrating an example of a display screen of a search result of the projector.

FIG. 9 is a diagram illustrating an example of a screen displayed by the information processing apparatus when connection is established.

FIG. 10 is a diagram illustrating an example of a GUI image displayed by the information processing apparatus.

FIG. 11 is a sequence diagram illustrating an example of an operation of turning off a projector.

FIG. 12 is a sequence diagram illustrating an example of an operation of turning off a projector.

FIG. 13 is a diagram illustrating an example of a screen displayed by the information processing apparatus when connection is established.

FIG. 14 is a sequence diagram illustrating an example of an operation of turning off a projector.

FIG. 15 is a diagram illustrating an example of a GUI image displayed by the information processing apparatus.

FIG. 16 is a sequence diagram illustrating an example of an operation of setting image quality in a dialog format.

FIG. 17 is a diagram illustrating an example of a screen displayed when the image quality is set in the dialog format.

FIG. 18 is a diagram illustrating an example of a screen displayed when the image quality is set in the dialog format.

FIG. 19 is a diagram illustrating an example of a screen displayed when the image quality is set in the dialog format.

FIG. 20 is a diagram illustrating an example of a screen displayed when the image quality is set in the dialog format.

FIG. 21 is a diagram illustrating an example of a screen displayed when the image quality is set in the dialog format.

FIG. 22 is a diagram illustrating an example of a screen displayed when the image quality is set in the dialog format.

FIG. 23 is a sequence diagram illustrating an example of an operation of returning the image quality set in the dialog format to the image quality before change.

FIG. 24 is a sequence diagram illustrating an operation example when the image quality set in the dialog format is stored.

FIG. 25 is a sequence diagram illustrating an operation example when the image quality set in the dialog format is not stored.

### DESCRIPTION OF EXEMPLARY EMBODIMENTS

### Embodiments

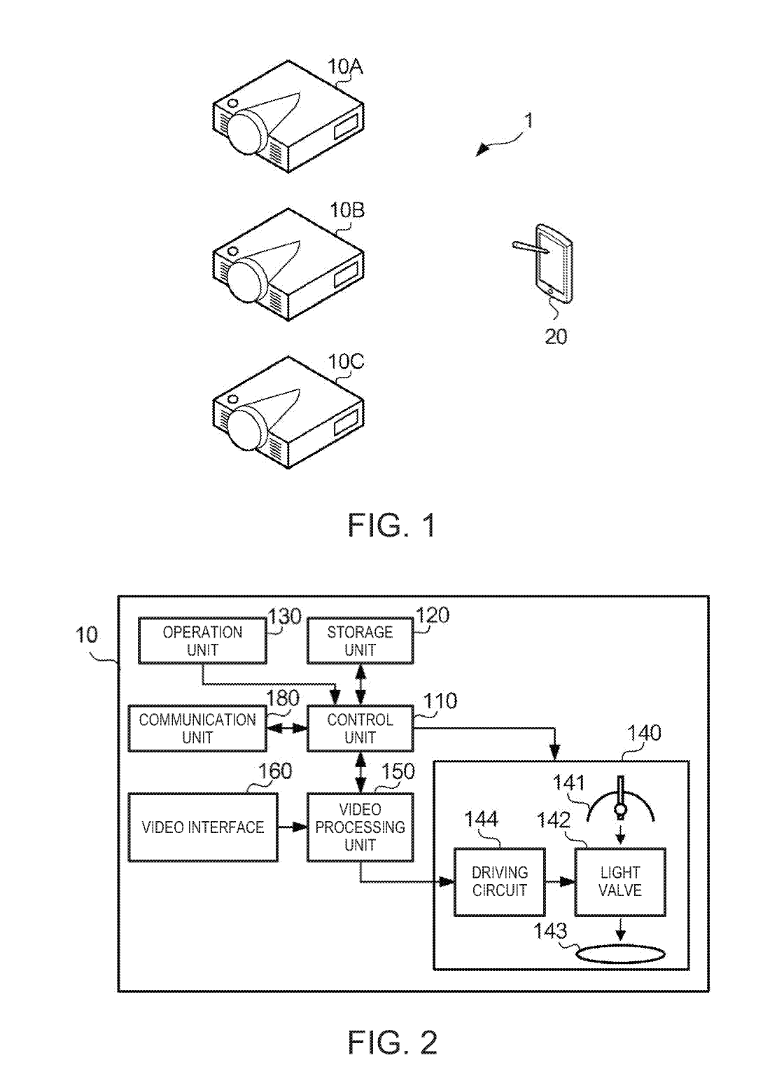

FIG. 1 is a diagram illustrating an apparatus related to a display system 1 according to an embodiment of the invention. Projectors 10A to 10C are examples of display apparatuses that project images indicated by video signals supplied from external apparatuses or images indicated by image data acquired from external apparatuses to screens or wall surfaces. Hereinafter, in a case in which it is not necessary to distinguish the projectors 10A to 10C from each other, the projectors 10A to 10C are referred to as projectors 10. An information processing apparatus 20 according to the embodiment is a so-called smartphone. The information processing apparatus 20 stores an application program that has a function of controlling the projectors 10A to 10C. The information processing apparatus 20 executing the application program is connected to one of the projectors 10A to 10C through wireless communication and controls the connected projector according to an operation of a user. That is, the information processing apparatus 20 functions as a remote controller that operates the projector 10 by executing the application program.

### Configurations of Projectors 10A to 10C

FIG. 2 is a diagram illustrating hardware configurations of projectors 10A to 10C. In the embodiment, the basic hardware configurations of the projectors 10A to 10C are the same. In a case in which it is necessary to distinguish units of the projectors 10A to 10C from each other, “A” is suffixed to each reference numeral of each unit of the projector 10A, “B” is suffixed to each reference numeral of each unit of the projector 10B, and “C” is suffixed to each reference numeral of each unit of the projector 10C in the description to facilitate the description. In a case in which it is not necessary to distinguish units of the projectors 10A to 10C from each other, “A”, “B”, and “C” are not suffixed to reference numerals in the description.

The projector 10 includes a control unit 110, a storage unit 120, an operation unit 130, and a projection unit 140. The projector 10 further includes a video processing unit 150, a video interface 160, and a communication unit 180.

The control unit 110 is a microcomputer that includes a central processing unit (CPU), a read-only memory (ROM), and a random access memory (RAM). When the CPU executes a program stored in the ROM in the projector 10A, the control unit 110A controls each unit to realize a function of projecting an image, a function of communicating with an external apparatus, a function of a server apparatus of a client server system (hereinafter referred to as a server function), a network standby function, and the like.

The network standby function is a function of supplying power to the control unit 110 and the communication unit 180 to communicate with an external apparatus even when the projector 10 is turned off by a power button of the operation unit 130A, a remote controller, or the like in a state in which the power can be supplied to the projector 10 via a power cord, an AC adapter, or the like. In a case in which this function is set to be valid, the power is supplied to the control unit 110A and the communication unit 180A even when the projector 10A is turned off by a power button of the operation unit 130A, a power button of the remote controller, or control of the information processing apparatus 20. In a case in which this function is set to be invalid, the power is supplied to the control unit 110A and no power is supplied to the communication unit 180A when the projector 10A is turned off by the power button of the operation unit 130A, the power button of the remote controller, or control of the information processing apparatus 20.

In the embodiment, a program stored in the ROM of the control unit 110B is different from a program of the control unit 110A in that the server function is realized and the network standby function is not realized. A program stored in the ROM of the control unit 110C is different from a program of the control unit 110A in that neither the server function nor the network standby function is realized.

The storage unit 120 stores information regarding setting of various functions and setting related to image quality of an image to be projected. The operation unit 130 includes a plurality of buttons for operating the projector 10. When the control unit 110 controls each unit according to an operated button, adjustment of an image to be projected or setting of various functions of the projector 10 is performed. The operation unit 130 includes a light reception unit (not illustrated) that receives an infrared signal from a remote controller (not illustrated). The operation unit 130 converts the infrared signal transmitted from the remote controller into an electric signal and supplies the electric signal to the control unit 110. The control unit 110 controls each unit according to the supplied signal.

The communication unit 180 includes a communication interface of wired communication, a communication interface of wireless communication in conformity to the IEEE 802.11 standard, a communication interface of Bluetooth (registered trademark), and a communication interface of universal serial bus (USB) and communicates with other computer apparatuses via various interfaces. The communication unit 180 is an example of a communication section that is connected to the projector 10 to perform communication.

The video interface 160 is an example of a video signal acquisition section that acquires a video signal. The video interface 160 includes a connector such as RCA, D-Sub, or HDMI (registered trademark) and supplies the video processing unit 150 with a video signal supplied from an external apparatus to the connector. The video processing unit 150 acquires the video signal supplied from the video interface 160. The video processing unit 150 acquires a signal of an on-screen image of a graphical user interface (GUI), a menu, or the like for operating the projector 10 from the control unit 110. The video processing unit 150 includes various image processing functions and performs image processing on the video signal supplied from the video interface 160 to adjust the image quality of an image to be projected. The video processing unit 150 supplies the video signal with the adjusted image quality to the projection unit 140. In a case in which the signal of the on-screen image is supplied from the control unit 110, the video processing unit 150 supplies the projection unit 140 with a video signal on which the signal of the on-screen image is superimposed.

The projection unit 140 that projects an image includes a light source 141, a light valve 142, a driving circuit 144, and a projection optical system 143. The light source 141 is a lamp that emits light. The light emitted from the light source 141 is separated into red light, green light, and blue light by a plurality of dichroic mirrors or mirrors (not illustrated). The separated red light, green light, and blue light are guided to the light valve 142. The light source 141 may be a light-emitting diode or a semiconductor laser apparatus that emits laser light rather than a lamp.

The driving circuit 144 acquires the video signal supplied from the video processing unit 150. The video signal supplied to the driving circuit 144 includes gray scale data indicating a gray scale of red components in an image to be projected, gray scale data indicating a gray scale of green components in the image to be projected, and gray scale data indicating a gray scale of blue components in the image to be projected. The driving circuit 144 extracts the gray scale data of each color of red, green, and blue and drives the light valve 142 based on the extracted gray scale of each color.

The light valve 142 includes a liquid crystal light valve on which the above-described red light is incident, a liquid crystal light value on which the above-described green light is incident, and a liquid crystal light valve on which the above-described blue light is incident. The liquid crystal light valve is a transmissive liquid crystal panel and includes pixels of a plurality of rows and a plurality of columns arrayed in a matrix form. The liquid crystal light valve on which the red light is incident is driven based on the red gray scale data. The liquid crystal light valve on which the green light is incident is driven based on the green gray scale data. The liquid crystal light valve on which the blue light is incident is driven based on the blue gray scale data. In each liquid crystal light valve, the pixels are controlled by the driving circuit 144 and transmittance of the pixels is changed. By controlling the transmittance of the pixels, light of each color transmitted through the liquid crystal light valve becomes an image corresponding to each piece of gray scale data. The images of the red light, the green light, and the blue light transmitted through the liquid crystal light valves are combined by a dichroic prism (not illustrated) to be incident on the projection optical system 143. The projection optical system 143 is an optical system that enlarges the incident image, and the incident image is enlarged by a lens or a mirror to be projected.

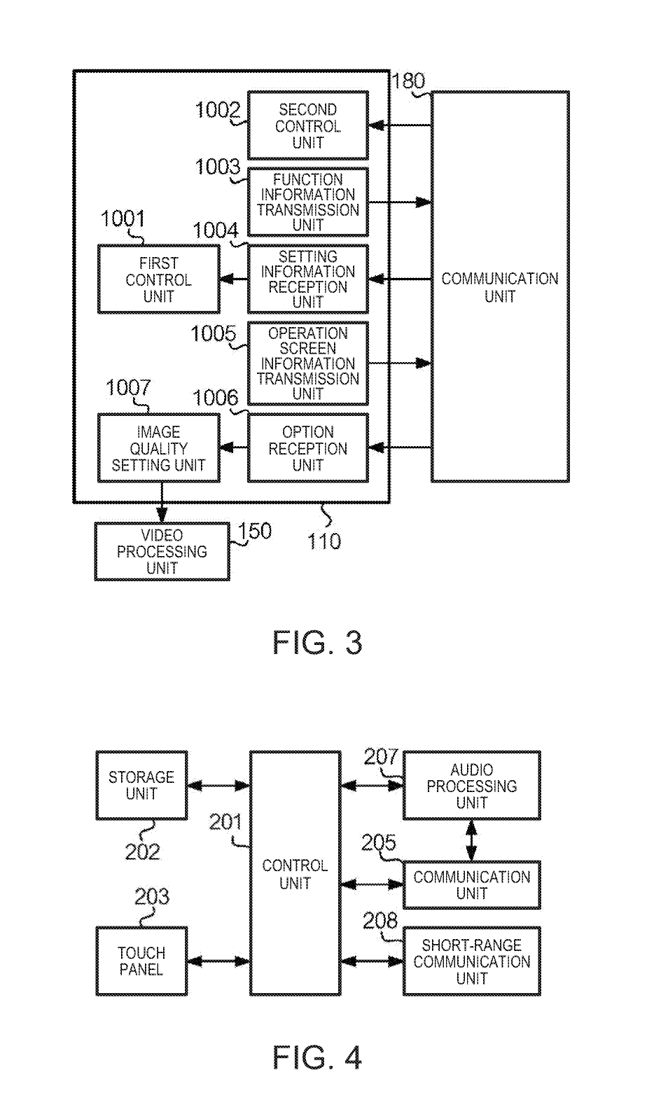

FIG. 3 is a functional block diagram of the projector 10 illustrating the configuration of a function realized by executing a program of the ROM by the control unit 110.

A first control unit 1001 is an example of a first control section that controls power supply to the communication unit 180 according to a setting state of the network standby function. In a case in which the network standby function is valid, the first control unit 1001 controls a power source (not illustrated) and supplies power to the communication unit 180 even when the projector is turned off. In a case in which the network standby function is invalid, the first control unit 1001 controls the power source (not illustrated) and stops supplying the power to the communication unit 180 when the projector is turned off.

A second control unit 1002 is an example of a second control section that turns on or off the projector. In a case in which the power is supplied to the communication unit 180 and the communication unit 180 receives a command to turn on or off the projector, the second control unit 1002 controls the power source (not illustrated) and turns on or off the projector.

A function information transmission unit 1003 is an example of a function information transmission section that transmits function information indicating a function of the projector 10 to the information processing apparatus 20.

A setting information reception unit 1004 is an example of a setting information reception section that receives setting information for validating or invalidating the network standby function from the information processing apparatus 20.

An operation screen information transmission unit 1005 is an example of an operation screen information transmission section that transmits operation screen information which is data of a GUI image for operating the projector 10. The operation screen information transmission unit 1005 is also an example of a transmission section that transmits data of a GUI image which is a setting image for setting the image quality of an image to be projected by the projector 10.

An option reception unit 1006 is an example of an option reception section that receives information indicating an option selected by the user among options present in the setting image for setting the image quality.

An image quality setting unit 1007 is an example of a setting section that controls the video processing unit 150 according to the option received by the option reception section and sets the image quality of an image to be projected.

Configuration of Information Processing Apparatus 20

FIG. 4 is a diagram illustrating an example of a hardware configuration of the information processing apparatus 20. A control unit 201 includes a CPU, a RAM, and a nonvolatile memory. When the CPU executes a program stored in the nonvolatile memory, an operation system of a smartphone functions.

A touch panel 203 is an apparatus in which a display apparatus (for example, a liquid crystal display) and a sensor detecting a touch of a finger on a display surface of the display apparatus are combined and is an example of an operation section that is operated by the user. The touch panel 203 displays letters, a GUI, or a menu screen or the like for operating the information processing apparatus 20 using a display apparatus. The touch panel 203 detects the position touched with a finger of the user using a sensor. The control unit 201 specifies an operation of the user according to the position detected by the touch panel 203 and a screen displayed on the touch panel and performs various processes or control of each unit according to the specified operation.

An audio processing unit 207 includes a microphone and a speaker. In a case in which the information processing apparatuses 20 perform audio communication, the audio processing unit 207 converts a supplied digital signal into an analog signal when the digital signal related to an audio of a communication partner is supplied from the communication unit 205. The analog signal is supplied to the speaker and the audio of the communication partner is output from the speaker. When the microphone collects an audio, the audio processing unit 207 converts the collected audio into a digital signal. In a case in which an audio call is performed with the information processing apparatus 20, the audio processing unit 207 supplies the communication unit 205 with the digital signal obtained by converting the audio of the user. The digital signal is transmitted from the communication unit 205 to a mobile communication network to be transmitted to the information processing apparatus 20 of the communication partner.

A short-range communication unit 208 includes a communication interface of wireless communication in conformity to the IEEE 802.11 standard. The short-range communication unit 208 receives radio waves for wireless communication transmitted from an external apparatus using an antenna and supplies a signal indicated by the received radio waves to the control unit 201. When the signal indicating information transmitted to the external apparatus is supplied from the control unit 201, the short-range communication unit 208 transmits radio waves indicating the signal supplied from the control unit 201 from an antenna.

In a case in which the short-range communication unit 208 communicates with the projector 10, the short-range communication unit 208 performs direct communication without passing through a wireless LAN router or a communication network. The short-range communication unit 208 can also perform communication with the projector 10 via a wireless LAN router or a communication network.

The storage unit 202 is a nonvolatile memory and stores various application programs or data used by the application programs. In the embodiment, the storage unit 202 stores an application program causing the information processing apparatus 20 to function as a controller of the projector 10 (hereinafter referred to as a control application).

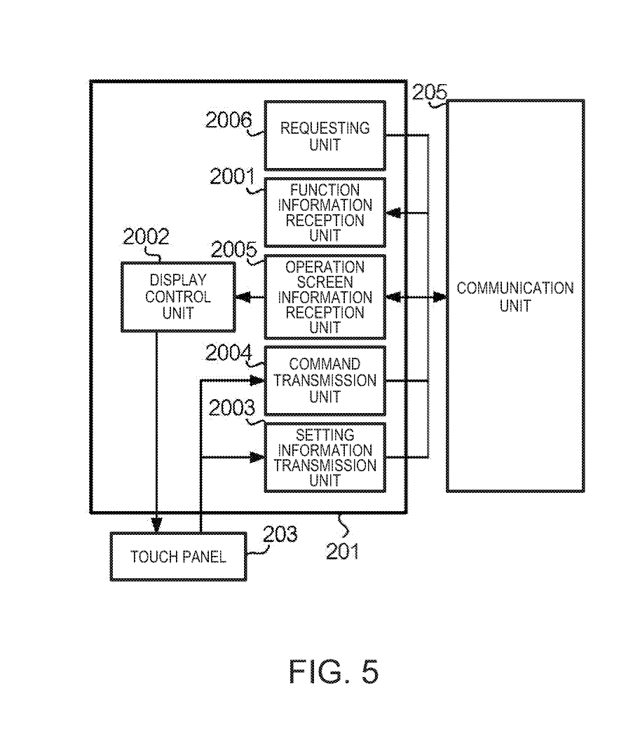

FIG. 5 is a functional block diagram of the information processing apparatus 20 illustrating the configuration of a function realized by executing a control application by the control unit 201.

A requesting unit 2006 is an example of a requesting section that requests the projector 10 to transmit function information indicating a function of the projector 10.

A function information reception unit 2001 is an example of a function information reception section that receives the function information indicating the function of the projector 10 from the projector 10.

An operation screen information reception unit 2005 is an example of an operation screen information reception section that receives a GUI image which is an operation screen for operating the projector 10 and an operation screen information for displaying an operation screen for setting the image quality of an image to be projected by the projector 10.

A display control unit 2002 controls the touch panel 203 such that a GUI image which is an operation screen according to the operation screen information received by the operation screen information reception unit 2005 is displayed. The display control unit 2002 is an example of a display control section that displays a GUI image.

A setting information transmission unit 2003 is an example of a setting information transmission section that transmits setting information used to validate or invalidate the network standby function to the projector 10 according to an operation performed on the touch panel 203.

A command transmission unit 2004 is an example of a command transmission section that transmits a command turning on or off the power of the projector 10 to the projector 10 according to an operation performed on the GUI image.

### Operation Example in Embodiment

Next, an operation example will be described when the information processing apparatus 20 and the projector 10 are connected through wireless communication using the control application, an operation example will be described when the power of the projector 10 is controlled by the information processing apparatus 20 connected through wireless communication, and an operation example will be described when the image quality of the image projected by the projector 10 is changed by the information processing apparatus 20 connected through wireless communication.

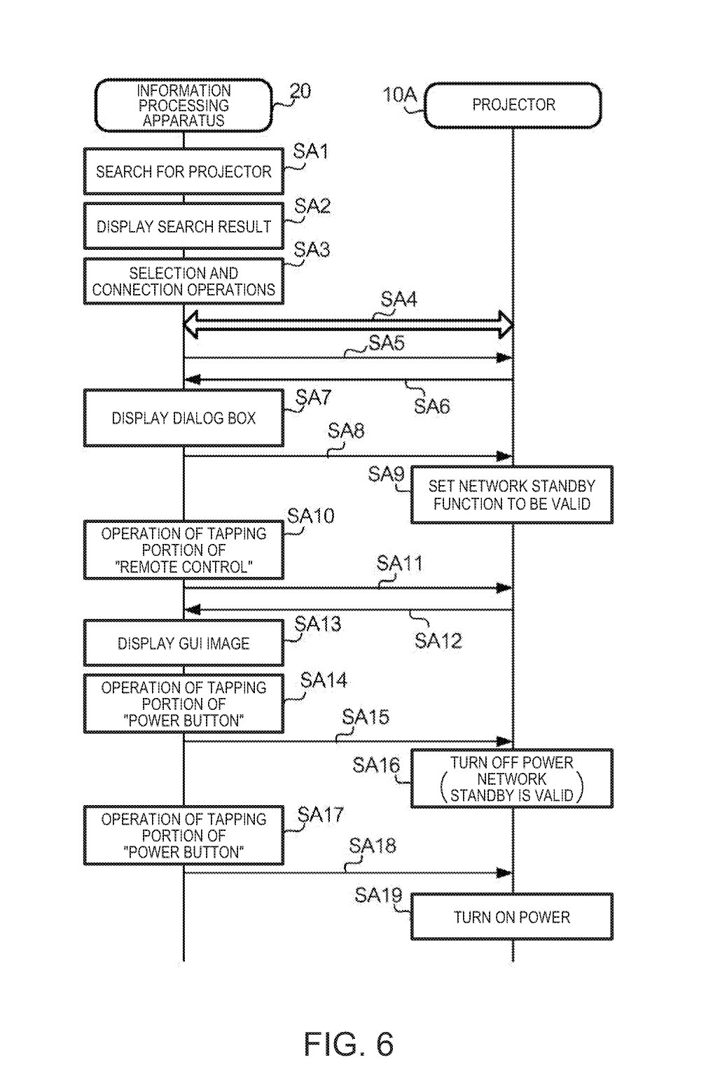

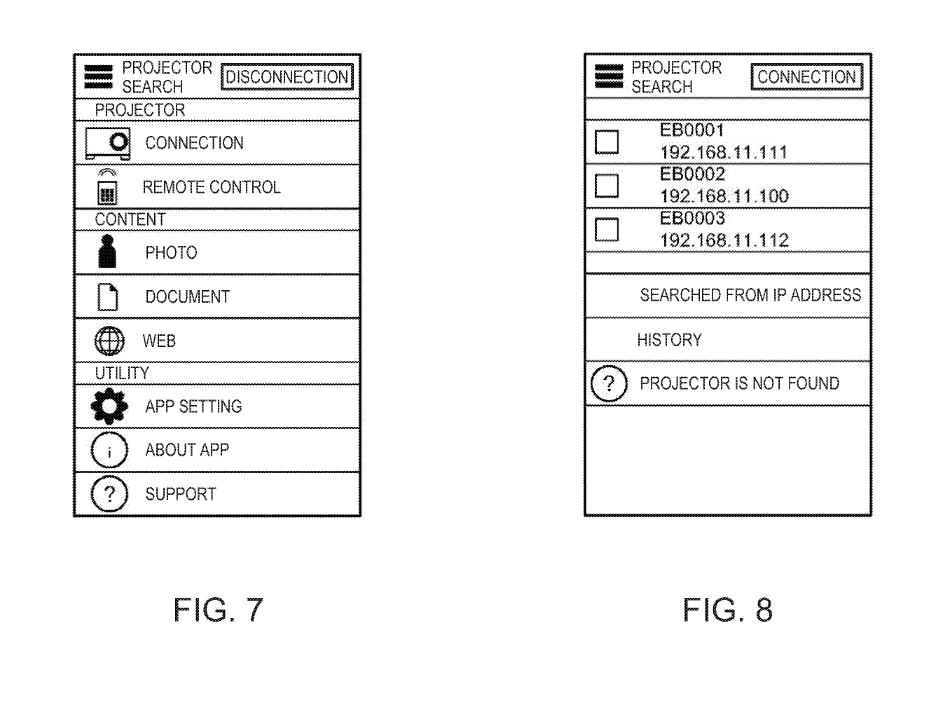

FIG. 6 is a sequence diagram illustrating an operation when the projector 10A is operated by the information processing apparatus 20 executing the control application. FIG. 7 is a diagram illustrating an example of a screen displayed by the information processing apparatus 20 executing the control application.

When the user performs an operation of tapping a portion “projector search” in FIG. 7 on the touch panel 203, the control unit 201 searches for the projector 10 capable of establishing communication connection by controlling the short-range communication unit 208 (step SA1). As a method of searching for the projector 10, for example, a technology disclosed in JP-A-2006-196946 can be adopted. When the search of the connectable projector 10 ends, the control unit 201 controls the touch panel 203 so that a screen of the search result is displayed (step SA2).

FIG. 8 is a diagram illustrating an example of a display screen of the search result. In FIG. 8, a case in which the projectors 10A to 10C are searched is exemplified. In FIG. 8, an IP address and an identifier of the projector 10A are shown in the first line of the search result, an IP address and an identifier of the projector 10B are shown in the second line, and an IP address and an identifier of the projector 10C are shown in the third line.

When the user performs an operation of checking on a check box in a line in which the IP address and the identifier of the projector 10A are displayed on the touch panel 203 and performs an operation of tapping a “connection” button on the upper right side (step SA3), the control unit 201 controls the short-range communication unit 208 such that wireless communication is performed to establish communication connection with the projector 10A (step SA4).

When the connection with the projector 10A is established, the control unit 201 transmits a message to inquire about a function of the projector 10A to the projector 10A (step SA5). When the communication unit 180A receives the message, the control unit 110A transmits function information indicating the function of the projector 10A to the information processing apparatus 20 (step SA6). Since the projector 10A has the server function and the network standby function, as described above, the function information transmitted from the projector 10A to the information processing apparatus 20 includes information indicating the server function and information indicating the network standby function, herein.

When the short-range communication unit 208 receives the function information transmitted from the projector 10A, the control unit 201 acquires the function information received by the short-range communication unit 208. When the control unit 201 acquires the function information, the control unit 201 controls the touch panel 203 such that a dialog box notifying the user of the connection to the projector 10 is displayed (step SA7). The control unit 201 determines whether the acquired function information includes the information indicating the network standby function when the dialog box is displayed. In a case in which the acquired function information includes the information indicating the network standby function, the control unit 201 controls the touch panel 203 such that a check box for inquiring of the user about whether to use a remote control function is displayed even when the projector 10 is turned off.

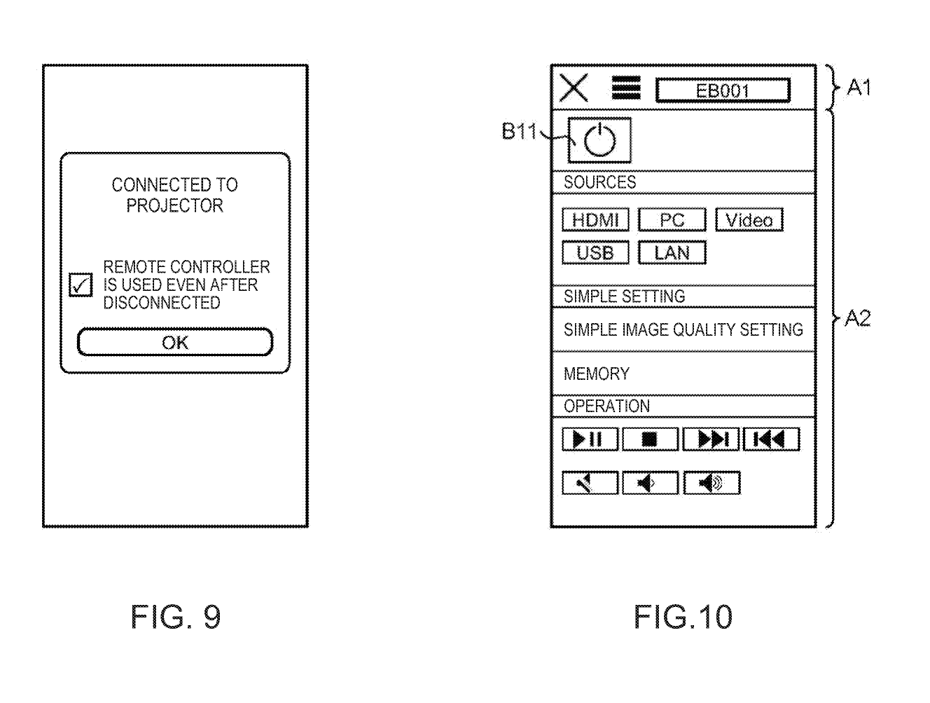

FIG. 9 is a diagram illustrating an example of a dialog box displayed by the information processing apparatus 20 herein. When the user performs an operation of checking on the displayed check box on the touch panel 203 and performs an operation of tapping an “OK” button in the dialog box, the control unit 201 transmits a command validating the network standby function to the projector 10A (step SA8). When the transmission of the command ends, the control unit 201 controls the touch panel 203 such that the menu screen illustrated in FIG. 7 is displayed.

When the communication unit 180A receives the command validating the network standby function, the control unit 110A acquires a command received by the communication unit 180A. When the control unit 110A acquires this command, the network standby function is set to be validated (step SA9).

Next, when the user performs an operation of tapping a portion of “remote control” on the touch panel 203 displayed on the screen of FIG. 7 (step SA10), the control unit 201 determines whether the function information transmitted in step SA6 includes the information indicating the server function. As described above, the function information transmitted from the projector 10A includes the information indicating the server function. In this case, the control unit 201 transmits a message requesting data of a GUI image which is an example of an operation image for operating the projector to the projector 10A by controlling the short-range communication unit 208 (step SA11).

When the communication unit 180A receives the message requesting the data of the GUI image, the control unit 110A acquires the message received by the communication unit 180A. When the control unit 110A acquires the message requesting the data of the GUI image, the control unit 110A transmits data of a GUI image for operating the projector 10A to the information processing apparatus 20 by controlling the communication unit 180A (step SA12). In the embodiment, the data of the GUI image is described with the HyperText Markup Language (HTML).

When the short-range communication unit 208 receives the data of the GUI image transmitted from the projector 10A, the control unit 201 acquires the data received by the short-range communication unit 208. The control unit 201 generates the GUI image according to the acquired data and controls the touch panel 203 such that the generated GUI image is displayed (step SA13).

FIG. 10 is a diagram illustrating an example of a GUI image displayed on the touch panel 203 herein. In FIG. 10, a display region A1 is a region in which a control image (a common operation screen) included in advance as resources is displayed by a control application and a display region A2 is a region in which a screen generated according to data (which is an example of second common operation screen information) of a GUI image is displayed. In the display region A1, an identifier of the connected projector 10 is displayed. A GUI of a button in the display region A2 can be realized by, for example, a button tag of HTML.

When the user performs an operation of tapping a power button B11 displayed on the touch panel 203 (step SA14), the control unit 201 acquires a letter string described in a value attribute of the button tag corresponding to the power button B11 in the HTML data of the GUI image. For example, a letter string “power” can be associated as a value attribute with the power button B11 herein. The letter string is an example of a command to turn on or off the projector 10. The control unit 201 controls the short-range communication unit 208 and transmits the acquired letter string to the projector 10A (step SA15).

When the communication unit 180A receives the letter string “power” transmitted from the information processing apparatus 20, the control unit 110A acquires the letter string received by the communication unit 180A. When the control unit 110A acquires the letter string “power”, the control unit 110A turns off the power, in a case in which the projector is turned on, and stops supplying power to the video processing unit 150 or the projection unit 140. In a case in which the network standby function is set to be valid, power supply to the communication unit 180A is not stopped (step SA16). Therefore, even when the projector 10A is turned off, the communication connection between the projector 10A and the information processing apparatus 20 remains established.

Next, when the user performs an operation of tapping the power button 311 displayed on the touch panel 203 (step SA17), the control unit 201 acquires the letter string described in the value attribute of the button tag corresponding to the power button B11 in the HTML data of the GUI image. The control unit 201 controls the short-range communication unit 208 and transmits the acquired letter string (“power”) to the projector 10A (step SA18).

When the communication unit 180A receives the letter string “power” transmitted from the information processing apparatus 20, the control unit 110A acquires the letter string received by the communication unit 180A. When the control unit 110A acquires the letter string “power”, the control unit 110A turns on the power, in a case in which the projector is turned off, and supplies the power to the units to which the power supply has been stopped (step SA19).

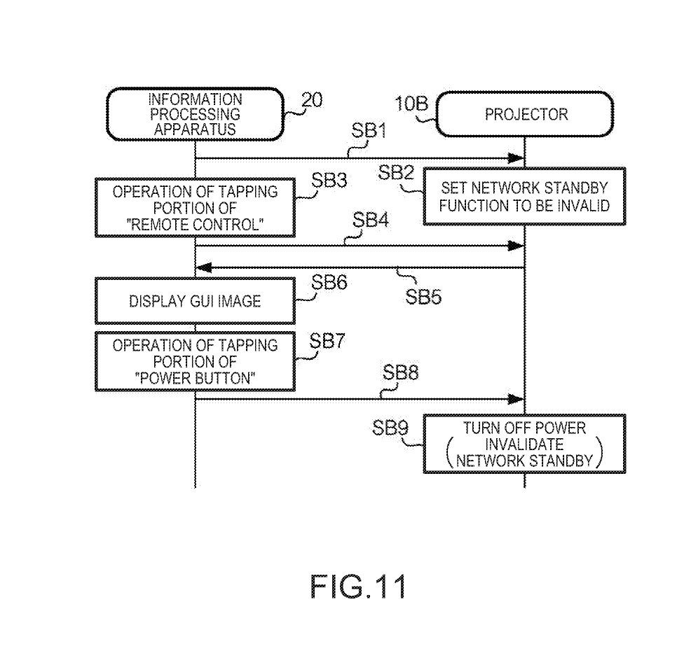

Next, an operation example in the case of invalidating the network standby function will be described with reference to the sequence diagram of FIG. 11. In the following description, the operation example will be described assuming that the processes of steps SA1 to SA7 have already been performed.

When the user performs an operation of turning off the displayed check box on the screen of FIG. 9 of the touch panel 203 and performs an operation of tapping an “OK” button in a dialog box, the control unit 201 transmits a command to invalidate the network standby function to the projector 10A (step SB1). When the transmission of the command ends, the control unit 201 controls the touch panel 203 such that the screen of FIG. 7 is displayed.

When the communication unit 180A receives the command to invalidate the network standby function, the control unit 110A acquires the command received by the communication unit 180A. When the control unit 110A acquires this command, the control unit 110A sets the network standby function to be invalid (step SB2).

Next, when user performs an operation of tapping a portion of “remote control” on the touch panel 203 displaying the screen of FIG. 7 (step SB3), the information processing apparatus 20 and the projector 10A perform communication and perform the same processes as those of steps SA11 to SA13 of the above-described operation example so that a screen illustrated in FIG. 10 is displayed on the touch panel 203 (steps SB4 to SB6).

When the user performs an operation of tapping the power button B11 displayed on the touch panel 203 (step SB7), the control unit 201 acquires a letter string described in a value attribute of a button tag corresponding to the power button Ell in HTML data of a GUI image. The control unit 201 controls the short-range communication unit 208 to transmit the acquired letter string (“power”) to the projector 10A (step SB8).

When the communication unit 180A receives the letter string “power” transmitted from the information processing apparatus 20, the control unit 110A acquires the letter string received by the communication unit 180A. When the control unit 110A acquires the letter string “power”, the control unit 110A turns off power, in the case in which the projector is turned on, and stops supplying the power to the video processing unit 150 or the projection unit 140. In a case in which the network standby function is set to be invalid when the control unit 110A acquires the letter string “power”, power supply to the communication unit 180A is also stopped (step SB9). Since the power supply to the communication unit 180A is stopped, the communication between the projector 10A and the information processing apparatus 20 is disconnected. When the communication with the projector 10A is disconnected, the control unit 201 controls the touch panel 203 such that the screen of FIG. 7 is displayed.

In this way, in the case in which the user invalidates the network standby function, the power supply to the communication unit 180A is stopped when the power is turned off. Therefore, the wireless communication of the projector 10A in conformity to the IEEE 802.11 standard is disabled, and thus the information processing apparatus 20 may not turn on the projector 10A through the wireless communication. In this case, to turn on the projector 10A, the user operates the power button of the remote controller or the operation unit 130A to turn on the projector 10A.

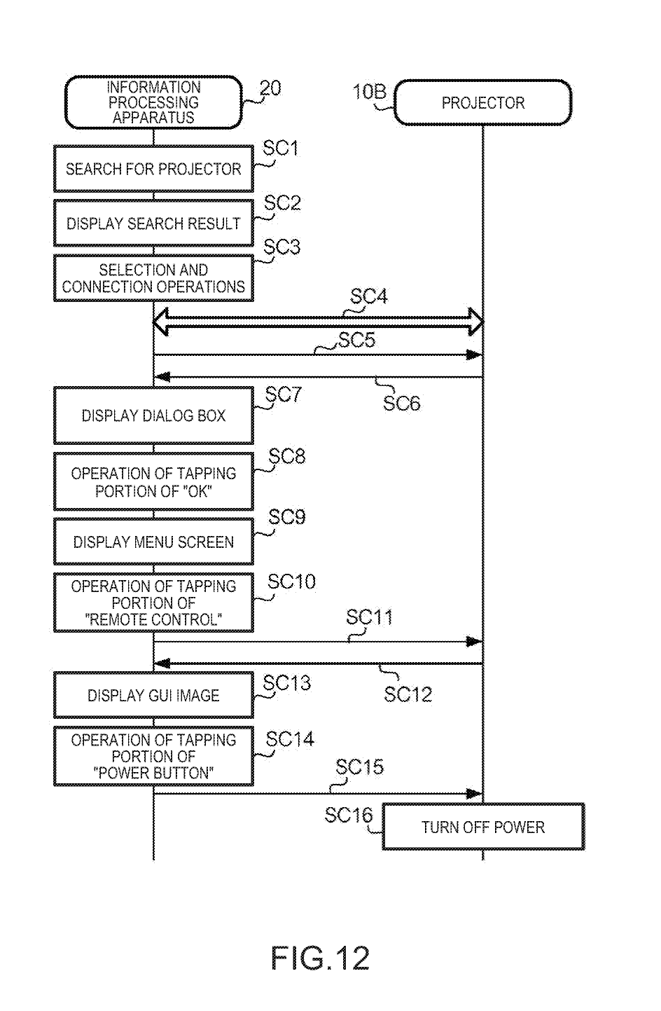

Next, an operation example when the information processing apparatus 20 is connected to the projector 10B which does not have the network standby function will be described with reference to the sequence diagram of FIG. 12. In the following description, an operation example will be described assuming that the same processes (steps SC1 and SC2) as those of steps SA1 and SA2 have already been executed.

When the user performs an operation of checking on a check box in a line in which the IP address and the identifier of the projector 10B are displayed on the touch panel 203 in a state in which the screen of FIG. 8 is displayed and performs an operation of tapping a “connection” button on the top right side (step SC3), the control unit 201 controls the short-range communication unit 208 such that wireless communication is performed to establish communication connection with the projector 10B (step SC4).

When the connection with the projector 10B is established, the control unit 201 transmits a message to inquire about a function of the projector 10B to the projector 10B (step SC5). When the communication unit 180B receives the message, the control unit 110B transmits function information indicating the function of the projector 10B to the information processing apparatus 20 (step SC5). Since the projector 10B has the server function, but does not have the network standby function, as described above, the function information transmitted to the information processing apparatus 20 herein includes the information indicating the server function and does not include information indicating the network standby function.

When the short-range communication unit 208 receives the function information transmitted from the projector 10B, the control unit 201 acquires the function information received by the short-range communication unit 208. When the control unit 201 acquires the function information, the control unit 201 controls the touch panel 203 such that a dialog box notifying the user of the connection to the projector 10 is displayed (step SC7). The control unit 201 determines whether the acquired function information includes the information indicating the network standby function when the dialog box is displayed. In a case in which the acquired function information does not include the information indicating the network standby function, the control unit 201 controls the touch panel 203 such that a check box for inquiring of the user about whether to use a remote control function is not displayed even when the projector is turned off.

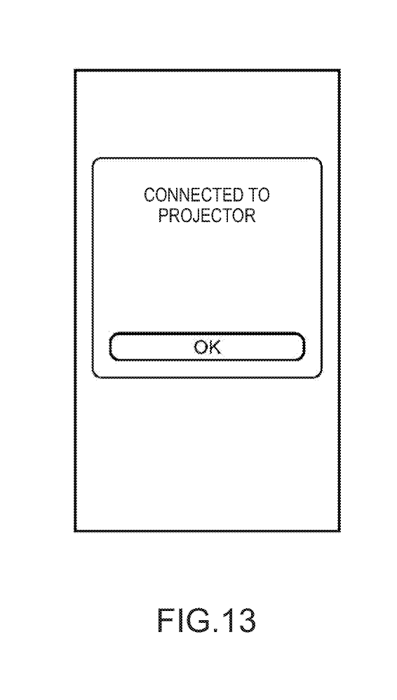

FIG. 13 is a diagram illustrating an example of a dialog box displayed by the information processing apparatus 20 herein. When the user performs an operation of tapping an “OK” button in the dialog box (step SC8), the control unit 201 controls the touch panel 203 such that the menu screen illustrated in FIG. 7 is displayed (step SC9). Next, when the user performs an operation of tapping a portion of “remote control” on the touch panel 203 displaying the screen of FIG. 7 (step SC10), the control unit 201 determines whether the function information acquired in step SC6 includes the information indicating the server function. As described above, the function information acquired from the projector 10B includes the information indicating the server function. In this case, the control unit 201 transmits a message requesting data of a GUI image for operating the projector to the projector 10B by controlling the short-range communication unit 208 (step SC11).

After the information processing apparatus 20 transmits the message requesting the data of the GUI image, the data of the GUI image is acquired. Since the operations (steps SC12 and SC13) until the GUI image is displayed according to the acquired data are the same as the operation example at the time of connection to the projector 10A, as described above, the description thereof will be omitted.

Next, when the user performs an operation of tapping the displayed power button B11 in a state in which the screen of FIG. 10 is displayed on the touch panel 203 (step SC14), the control unit 201 acquires the letter string described in the value attribute of the button tag corresponding to the power button B11 in the HTML data of the GUI image. The control unit 201 controls the short-range communication unit 208 and transmits the acquired letter string (“power”) to the projector 10B (step SC15).

When the communication unit 180B receives the letter string “power” transmitted from the information processing apparatus 20, the control unit 110E acquires the letter string received by the communication unit 1803. When the control unit 110B acquires the letter string “power”, the control unit 110B turns off the power, in the case in which the projector is turned on, and stops supplying power to the video processing unit 150 or the projection unit 140. Since the projector does not have the network standby function, the control unit 110B also stops supplying the power to the communication unit 180B (step SC16). Since the power supply to the communication unit 180B is stopped, the communication between the projector 10B and the information processing apparatus 20 is disconnected. When the communication with the projector 10B is disconnected, the control unit 201 controls the touch panel 203 such that the screen of FIG. 7 is displayed.

In this way, in the case of the connection to the projector 10B which does not have the network standby function, the power supply to the communication unit 180B is stopped when the power is turned off. Therefore, the wireless communication of the projector 10B in conformity to the IEEE 802.11 standard is disabled, and thus the information processing apparatus 20 may not turn on the projector 10B through the wireless communication. In this case, to turn on the projector 10B, the user operates the power button of the remote controller or the operation unit 130B to turn on the projector 10B.

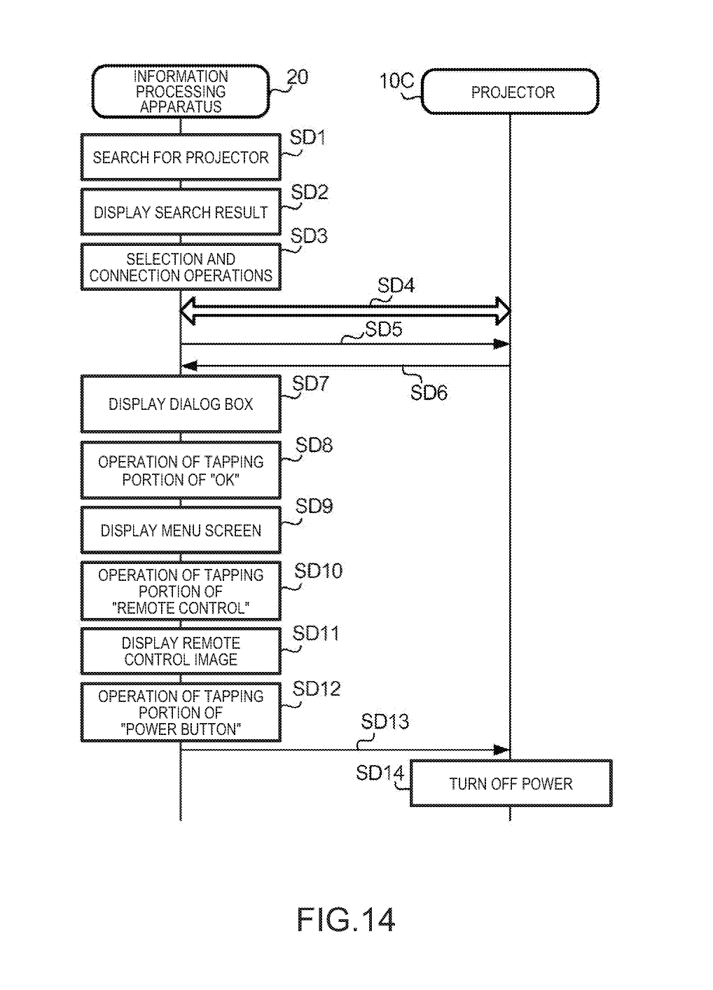

Next, an operation example when the information processing apparatus 20 is connected to the projector 10C which does not have the server function and the network standby function will be described with reference to the sequence diagram of FIG. 14. In the following description, an operation example will be described assuming that the same processes (steps SD1 and SD2) as those of steps SA1 and SA2 have already been executed.

When the user performs an operation of checking on a check box in a line in which the IP address and the identifier of the projector 10C are displayed on the touch panel 203 in a state in which the screen of FIG. 8 is displayed and performs an operation of tapping a “connection” button on the top right side (step SD3), the control unit 201 controls the short-range communication unit 208 such that wireless communication is performed to establish communication connection with the projector 10C (step SD4).

When the connection with the projector 10C is established, the control unit 201 transmits a message to inquire about a function of the projector 10C to the projector 10C (step SD5) When the communication unit 180C receives the message, the control unit 1100 transmits function information indicating the function of the projector 10C to the information processing apparatus 20 (step SD6). Since the projector 10C does not have the server function and the network standby function, as described above, the function information transmitted to the information processing apparatus 20 herein does not include the information indicating the server function and information indicating the network standby function.

When the short-range communication unit 208 receives the function information transmitted from the projector 10C, the control unit 201 acquires the function information received by the short-range communication unit 208. When the control unit 201 acquires the function information, the control unit 201 controls the touch panel 203 such that a dialog box notifying the user of the connection to the projector 10 is displayed (step SD7). The control unit 201 determines whether the acquired function information includes the information indicating the network standby function when the dialog box is displayed. In a case in which the acquired function information does not include the information indicating the network standby function, the control unit 201 controls the touch panel 203 such that a check box for inquiring of the user about whether to use a remote control function is not displayed even when the projector is turned off.

When the user performs an operation of tapping an “OK” button in the dialog box (step SD8), the control unit 201 controls the touch panel 203 such that the menu screen illustrated in FIG. 7 is displayed (step SD9). Next, when the user performs an operation of tapping a portion of “remote control” on the touch panel 203 displaying the screen of FIG. 7 (step SD10), the control unit 201 determines whether the function information acquired in step SD6 includes the information indicating the server function. As described above, the function information acquired from the projector 10C does not include the information indicating the server function. In this case, the control unit 201 controls the touch panel 203 such that the operation screen according to the common operation screen information included as resources in advance by the control application is displayed (step SD11). As described above, since the control application is stored in the storage unit 202, the common operation screen information included as the resources in advance by the control application is also stored in the storage unit 202. That is, the storage unit 202 is an example of a storage section that stores the common operation screen information. First common operation screen information is an example of the common operation screen information stored by the storage unit 202.

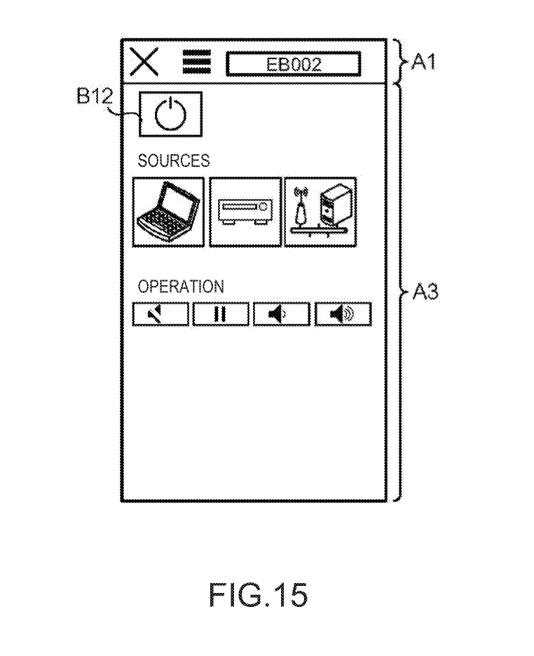

FIG. 15 is a diagram illustrating an example of a GUI image displayed on the touch panel 203 herein. In FIG. 15, a display region A3 is a region in which images of buttons included as the resources in advance by the control applications are displayed. Here, buttons used for common operations to the projectors 10A to 10C, such as operations of turning on/off power and converting video sources, are displayed in the displayed GUI image. When the user performs an operation of tapping a displayed power button B12 on the touch panel 203 (step SD12), the control unit 201 controls the short-range communication unit 208 such that a letter string “power” associated with the power button B12 is transmitted to the projector 10C (step SD13).

When the communication unit 180C receives the letter string “power” transmitted from the information processing apparatus 20, the control unit 110C acquires the letter string received by the communication unit 180C. When the control unit 110C acquires the letter string “power”, the control unit 110C turns off the power, in the case in which the projector is turned on, and stops supplying power to the video processing unit 150 or the projection unit 140. Since the projector does not have the network standby function, the control unit 110C also stops supplying the power to the communication unit 180C (step SD14). Since the power supply to the communication unit 180C is stopped, the communication between the projector 10C and the information processing apparatus 20 is disconnected. When the communication with the projector 10C is disconnected, the control unit 201 controls the touch panel 203 such that the screen of FIG. 7 is displayed.

In this way, even when the information processing apparatus 20 is connected to the projector 10C which does not have the server function, the information processing apparatus 20 can display the GUI image according to the data of the GUI image included as the resources in advance by the control application for the common operation to the projectors 10 and can operate the projector 10C through the wireless communication.

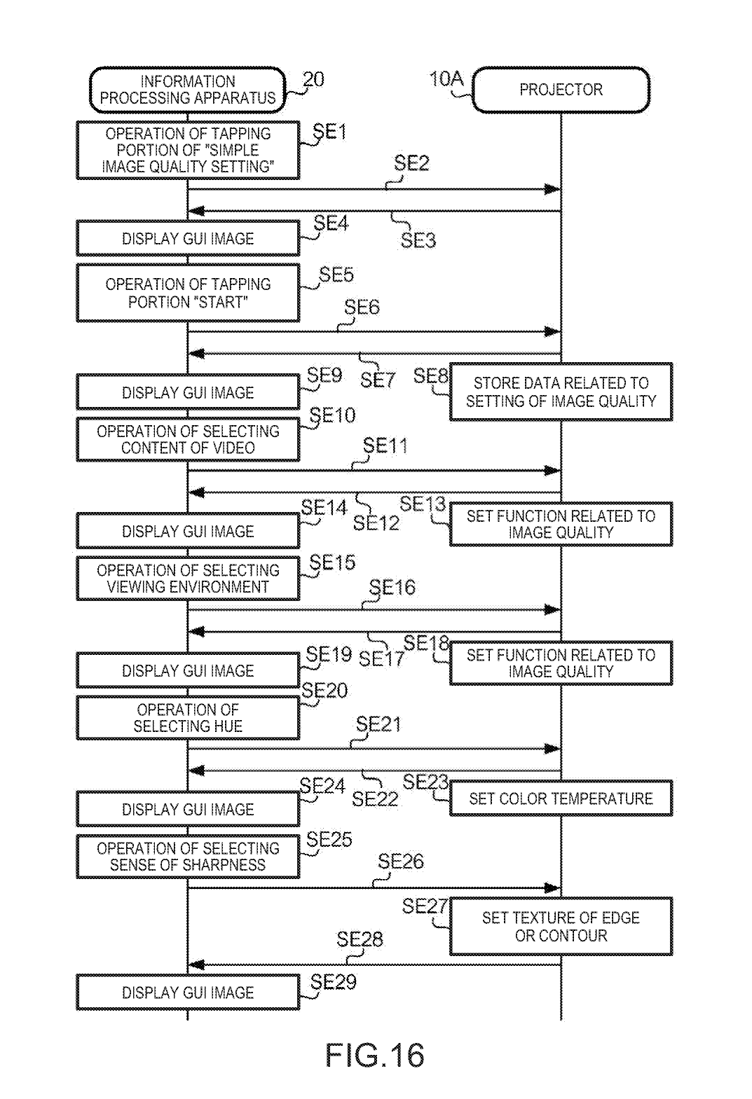

Next, an operation example in a case in which the projector 10 performs setting of image quality of an image to be projected in a dialog format will be described with reference to the sequence diagram of FIG. 16. In the following description, the operation example will be described assuming that the information processing apparatus 20 is connected to the projector 10A.

When the user performs an operation of tapping a portion of “simple image quality setting” in a state in which the GUI image of FIG. 10 is displayed on the touch panel 203 (step SE1), the control unit 201 acquires a letter string described in a value attribute of a button tag corresponding to the tapped portion in HTML data of the GUI image. The control unit 201 controls the short-range communication unit 208 such that the acquired letter string is transmitted to the projector 10A (step SE2). When the communication unit 180A receives the letter string transmitted from the information processing apparatus 20, the control unit 110A acquires the letter string received by the communication unit 180A and controls the communication unit 180A to transmit data of the GUI image corresponding to the acquired letter string to the information processing apparatus 20 (step SE3).

When the short-range communication unit 208 receives the data of the GUI image transmitted from the projector 10A, the control unit 201 acquires the data received by the short-range communication unit 208. The control unit 201 generates a GUI image according to the acquired data and controls the touch panel 203 such that the generated GUI image is displayed (step SE4).

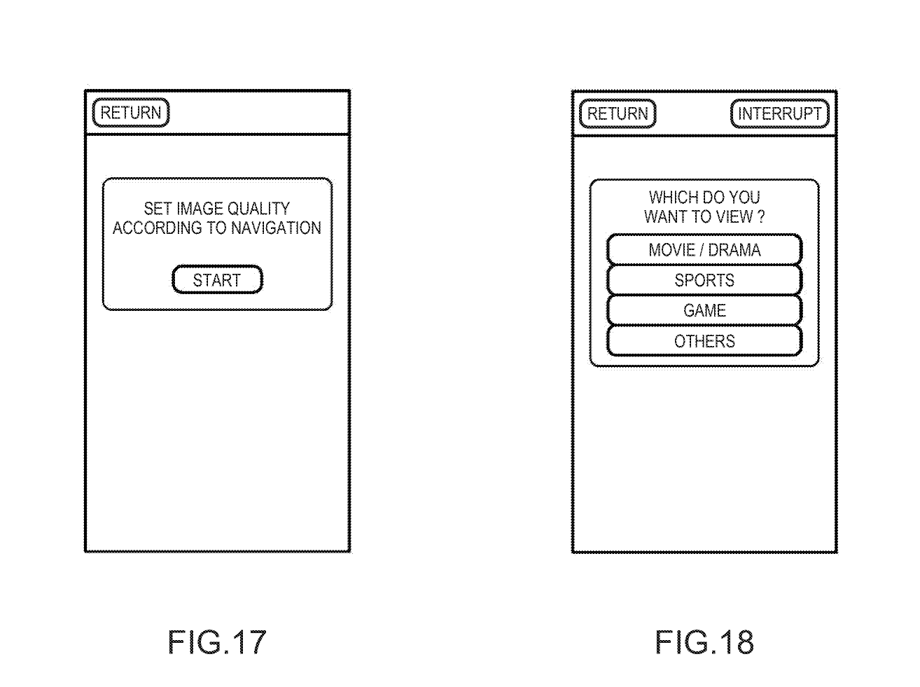

FIG. 17 is a diagram illustrating an example of a GUI image displayed on the touch panel 203 herein. When the user performs an operation of tapping a portion of “start” (step SE5), the control unit 201 transmits the letter string described in the value attribute of the button tag corresponding to the tapped portion in the HTML data of the GUI image to the projector 10A (step SE6). Then, the projector 10A controls the communication unit 180A such that the data of the GUI image corresponding to the transmitted letter string is transmitted to the information processing apparatus 20 (step SE7). The control unit 110A stores the data related to the setting of the image quality at this time point in the storage unit 120A (step SE8).

When the short-range communication unit 208 receives the data of the GUI image transmitted from the projector 10A, the control unit 201 generates the GUI image according to the data received by the short-range communication unit 208 and controls the touch panel 203 such that the generated GUI image is displayed (step SE9).

FIG. 18 is a diagram illustrating an example of a GUI image displayed on the touch panel 203 herein. Here, the user selects content of a video to be viewed. When the user performs an operation of tapping one portion of “movie/drama”, “sports”, “game”, and “others” (step SE10), the control unit 201 transmits the letter string described in the value attribute of the button tag corresponding to the tapped portion in the HTML data of the GUI image to the projector 10A (step SE11).

When the communication unit 180A receives the letter string transmitted from the information processing apparatus 20, the control unit 110A acquires the letter string received by the communication unit 180A and controls the communication unit 180A such that the data of the GUI image to be subsequently displayed by the information processing apparatus 20 is transmitted to the information processing apparatus 20 (step SE12). The control unit 110A sets the function related to the image quality according to the acquired letter string (step SE13). For example, in a case in which the letter string corresponding to the portion of “movie/drama” is acquired, the control unit 110A controls the video processing unit 150 such that a frame interpolation function is set to be on. In a case in which the letter string corresponding to the portion of “sports” or the letter string corresponding to the portion of “others” is acquired, the control unit 110A controls the video processing unit 150 such that the frame interpolation function is set to be off. In a case in which the letter string corresponding to the portion of “game” is acquired, the control unit 110A controls the video processing unit 150 such that the frame interpolation function is set to be off, a noise reduction function is set to be off, and a progressive conversion function is set to be off.

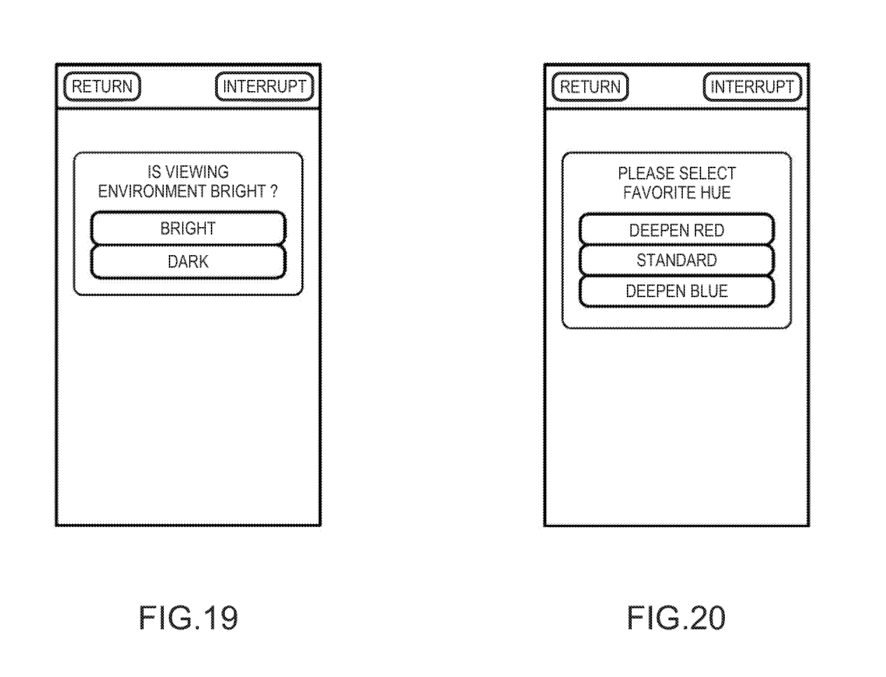

When the short-range communication unit 208 receives data of a GUI image transmitted from the projector 10A, the control unit 201 generates a GUI image according to the data received by the short-range communication unit 208 and controls the touch panel 203 such that the generated GUI image is displayed (step SE14). FIG. 19 is a diagram illustrating an example of a GUI image displayed on the touch panel 203 herein. Here, the user selects a viewing environment. When the user performs an operation of tapping a portion of “bright” or “dark” (step SE15), the control unit 201 transmits a letter string described in the value attribute of the button tag corresponding to the tapped portion in the HTML data of the GUI image to the projector 10A (step SE16).

When the communication unit 180A receives the letter string transmitted from the information processing apparatus 20, the control unit 110A acquires the letter string received by the communication unit 180A and controls the communication unit 180A such that the data of the GUI image to be subsequently displayed by the information processing apparatus 20 is transmitted to the information processing apparatus 20 (step SE17). The control unit 110A sets a function related to the image quality according to the acquired letter string (step SE18). For example, in a case in which the control unit 110A acquires the letter string corresponding to the portion of “bright”, the control unit 110A sets a color mode to “dynamic”. In a case in which the control unit 110A acquires the letter string corresponding to the portion of “dark”, the control unit 110A sets the color mode to “cinema”. The storage unit 120A stores setting values of brightness, contrast, color depth, hue, sharpness, and the like for each color mode in advance. The control unit 110 acquires the setting values of brightness, contrast, color depth, hue, and sharpness, and the like stored in advance in the storage unit 120A to correspond to the set color modes and controls the video processing unit 150 using the acquired setting values.

When the short-range communication unit 208 receives the data of the GUI image transmitted from the projector 10A, the control unit 201 generates the GUI image according to the data received by the short-range communication unit 208 and controls the touch panel 203 such that the generated GUI image is displayed (step SE19). FIG. 20 is a diagram illustrating an example of a GUI image displayed on the touch panel 203 herein. Here, the user selects the hue of an image to be projected (step SE20) When the user performs an operation of tapping one portion of “deepen red”, “standard”, and “deepen blue”, the control unit 201 transmits the letter string described in the value attribute of the button tag corresponding to the tapped portion in the HTML data of the GUI image to the projector 10A (step SE21).

When the communication unit 180A receives the letter string transmitted from the information processing apparatus 20, the control unit 110A acquires the letter string received by the communication unit 180A and controls the communication unit 180A such that the data of the GUI image to be subsequently displayed by the information processing apparatus 20 is transmitted to the information processing apparatus 20 (step SE22). The control unit 110A controls the video processing unit 150A according to the acquired letter string and performs setting of color temperature of the image to be projected (step SE23). For example, in a case in which the letter string corresponding to the portion of “deepen red” is acquired, the control unit 110A sets the color temperature to, for example, 5500K. In a case in which the letter string corresponding to the portion of “standard” is acquired, the control unit 110A sets the color temperature to, for example, 6500K. In a case in which the letter string corresponding to the portion of “deepen blue” is acquired, the control unit 110A sets the color temperature to, for example, 8000K. Such color temperatures are examples and other color temperatures may be used.

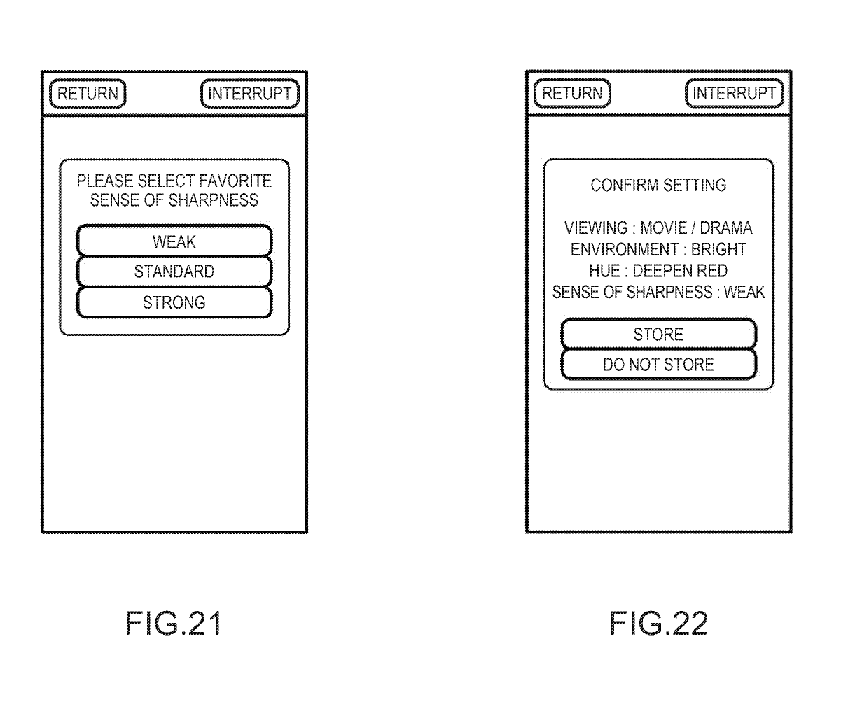

When the short-range communication unit 208 receives the data of the GUI image transmitted from the projector 10A, the control unit 201 generates the GUI image according to the data received by the short-range communication unit 208 and controls the touch panel 203 such that the generated GUI image is displayed (step SE24). FIG. 21 is a diagram illustrating an example of a GUI image displayed on the touch panel 203 herein. Here, the user selects a sense of sharpness (texture of edge or contour) of the image to be projected (step SE25). When the user performs an operation of tapping one portion of “strong”, “standard”, and “weak”, the control unit 201 transmits the letter string described in the value attribute of the button tag corresponding to the tapped portion in the HTML data of the GUI image to the projector 10A (step SE26).

When the communication unit 180A receives the letter string transmitted from the information processing apparatus 20, the control unit 110A acquires the letter string received by the communication unit 180A. The control unit 110A controls the video processing unit 150A according to the acquired letter string and performs setting of the enhancement degree of edge or contour of the image to be projected (step SE27). For example, in a case in which the letter string corresponding to the portion of “strong” is acquired, the control unit 110A sets the function of the enhancement of the edge or contour to be off. In a case in which the letter string corresponding to the portion of “standard” is acquired, the control unit 110A sets the function of the enhancement of the edge or contour to be on and sets the enhancement degree to the degree corresponding to “standard”. In a case in which the letter string corresponding to the portion of “weak” is acquired, the control unit 110A sets the function of the enhancement of the edge or contour to be on and sets the enhancement degree to the degree corresponding to “weak”.

Next, the control unit 110A generates data of a GUI image for confirming the setting performed by the user based on the letter strings transmitted from the information processing apparatus 20 in response to an operation on the screens in FIGS. 18 to 21 and transmits the generated data to the information processing apparatus 20 (step SE28). When the short-range communication unit 208 receives the data of the GUI image transmitted from the projector 10A, the control unit 201 generates a GUI image according to the data received by the short-range communication unit 208 and controls the touch panel 203 such that the generated GUI image is displayed (step SE29).

FIG. 22 is a diagram illustrating an example of a GUI image displayed on the touch panel 203 herein. As illustrated in FIG. 22, the items selected by the user on the screens in FIGS. 18 to 21 are displayed on the touch panel 203, so that the user can confirm content of the setting performed by the user. The user views the projected image and confirms the set image quality. According to the embodiment, various kinds of setting related to the image can be performed in the dialog formats and the user can view and confirm the setting result. Therefore, it is possible to simply set the image quality proper for the user's preference.

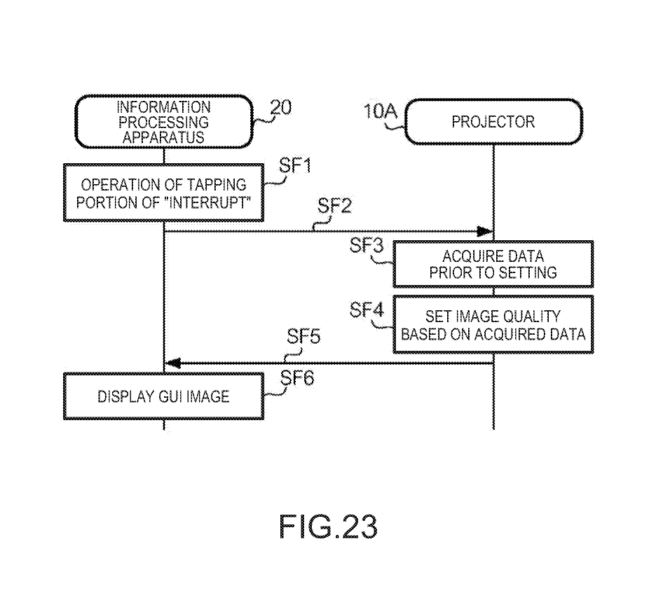

Next, an operation example in a case in which the setting of the set image quality is not stored and an operation example in a case in which the setting of the set image quality is stored will be described with reference to FIGS. 23 to 25.

In a case in which the set image quality is not preference image quality, the user performs an operation of tapping the portion of “interrupt,” on the screen (step SF1). When this operation is performed, the control unit 110A transmits the letter string described in the value attribute of the button tag corresponding to the tapped portion in the HTML data of the GUI image to the projector 10A (step SF2).

When the communication unit 180A receives the letter string transmitted from the information processing apparatus 20, the control unit 110A acquires the letter string received by the communication unit 180A. In a case in which the acquired letter string is the letter string corresponding to the portion of “interrupt”, the control unit 110A acquires the data stored in step SE8 before the setting of the image quality from the storage unit 120A (step SF3). The control unit 110A controls the video processing unit 150A based on the acquired data and returns the image quality of the image to be projected to the state prior to the setting of FIGS. 17 to 20 (step SF4).

When the process of step SF4 ends, the control unit 110A transmits the data of the GUI image in FIG. 10 to the information processing apparatus 20 (step SF5). When the short-range communication unit 208 receives the data of the GUI image transmitted from the projector 10A, the control unit 201 generates the GUI image according to the data received by the short-range communication unit 208 and controls the touch panel 203 such that the generated GUI image is displayed (step SF6).

In this way, according to the embodiment, in a case in which the image quality set in the dialog format is not the preference image quality, the user can easily return the image quality to the image quality prior to the performed setting.

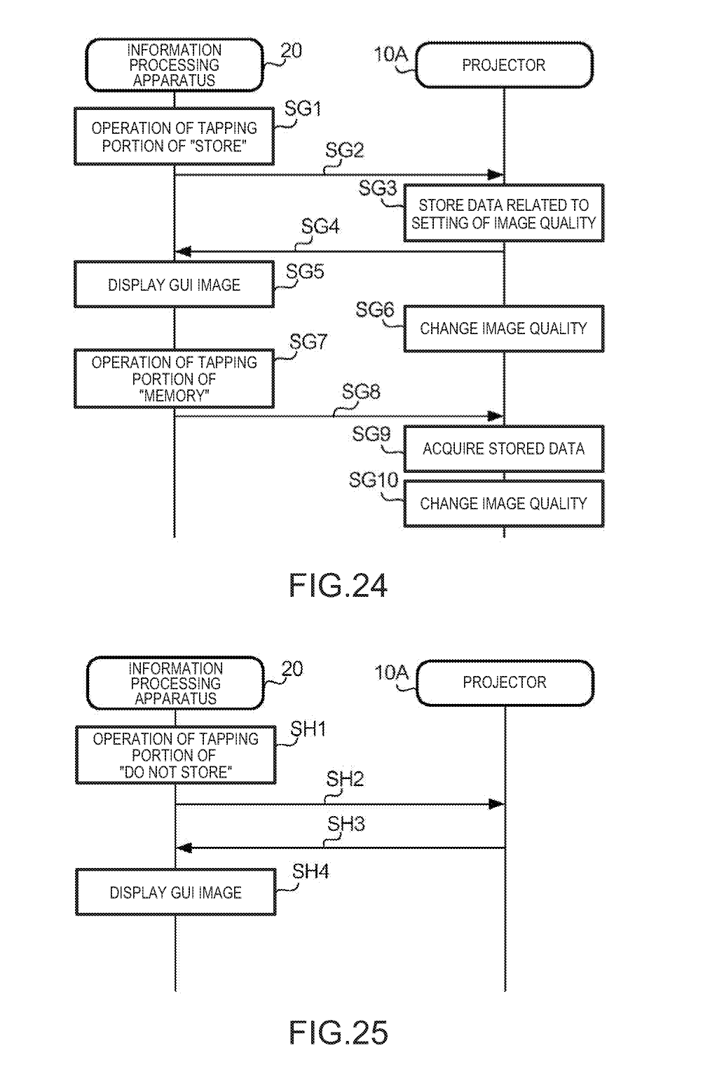

Conversely, in a case in which the set image quality is the preference image quality, the user selects whether the setting performed by the user is stored in the projector 10A. In a case in which the user stores the setting performed by the user in the projector 10A, the user taps a portion of “store” on the touch panel 203 on which the screen of FIG. 22 is displayed (step SG1 in FIG. 24). When this operation is performed, the control unit 201 transmits the letter string described in the value attribute of the button tag corresponding to the tapped portion in the HTML data of the GUI image to the projector 10A (step SG2).

When the communication unit 180A receives the letter string transmitted from the information processing apparatus 20, the control unit 110A acquires the letter string received by the communication unit 180A. In a case in which the control unit 110A acquires the letter string corresponding to the portion of “store”, the control unit 110A stores data related to the setting of the image quality performed on the screens in FIGS. 18 to 21 in the storage unit 120A (step SG3). When the storing of the data ends, the control unit 110A transmits the data of the GUI image in FIG. 10 to the information processing apparatus 20 (step SG4). When the short-range communication unit 208 receives the data of the GUI image transmitted from the projector 10A, the control unit 201 acquires the data received by the short-range communication unit 208. The control unit 201 generates the GUI image according to the acquired data and controls the touch panel 203 such that the generated GUI image is displayed (step SG5).

Thereafter, when the user operates the remote controller or the operation unit 130A to change the image quality (step SG6), the changed image quality is image quality different from the image quality set on the screens in FIGS. 17 to 20. When the user performs an operation of tapping the portion displayed as “memory” on the touch panel 203 on which the screen of FIG. 10 is displayed after the change in the image quality (step SG7), the control unit 110A transmits the letter string described in the value attribute of the button tag corresponding to the tapped portion in the HTML data of the GUI image to the projector 10A (step SG8). When the communication unit 180A receives the letter string transmitted from the information processing apparatus 20, the control unit 110A acquires the letter string received by the communication unit 180A. In a case in which the acquired letter string is the letter string corresponding to the portion of “memory”, the control unit 110A acquires the data stored in step SG3 from the storage unit 120A (step SG9). The control unit 110A controls the video processing unit 150A based on the acquired data such that the image quality of the image to be projected is changed into the image quality at the time of storage of the data in step SG3 (step SG10).

In this way, according to the embodiment, even when the image quality is changed from the image quality set in the dialog format, the changed image quality can be easily returned to the image quality set in the dialog format.

In a case in which the set image quality is the preference image quality and the setting performed by the user is not stored in the projector 10A, the user performs an operation of tapping the portion “do not store” on the touch panel 203 on which the screen of FIG. 22 is displayed (step SG1). When this operation is performed, the control unit 201 transmits the letter string described in the value attribute of the button tag corresponding to the tapped portion in the HTML data of the GUI image to the projector 10A (step SH2).

When the communication unit 180A receives the letter string transmitted from the information processing apparatus 20, the control unit 110A acquires the letter string received by the communication unit 180A. In a case in which the control unit 110A acquires the letter string corresponding to the portion of “do not store”, the control unit 110A does not store data related to the setting of the image quality performed on the screens in FIGS. 18 to 21 in the storage unit 120A and transmits the data of the GUI image in FIG. 10 to the information processing apparatus 20 (step SH3). When the short-range communication unit 208 receives the data of the GUI image transmitted from the projector 10A, the control unit 201 acquires the data received by the short-range communication unit 208. The control unit 201 generates the GUI image according to the acquired data and controls the touch panel 203 such that the generated GUI image is displayed (step SH4).

### Modification Examples

The embodiment of the invention has been described above, but the invention can be modified in various forms without being limited to the above-described embodiment. For example, the above-described embodiment may be modified in the following way to implement the invention. Singles and a plurality of the above-described embodiments and the following modification examples may be appropriately combined for implementation.

In the above-described embodiments, after the information processing apparatus 20 is connected to the projector 10, the identifier of the connected projector 10 is displayed in the display region A1. However, when the user inputs the identifier of another projector 10 in a text box in which the identifier is displayed, the information processing apparatus 20 may change a connection destination to the projector 10 with the input identifier.

In the invention, image data of a still image or a moving image stored in the information processing apparatus 20 may be transmitted from the information processing apparatus 20 to the connection destination projector 10 and the projector 10 may project an image (content) indicated by the image data transmitted from the information processing apparatus 20. When the image data is transmitted from the information processing apparatus 20 and the image is projected by the projector 10, a GUI for selecting the image data may be formed in the display region A1, the image data may be selected in response to an operation on the GUI, and the image to be projected may be changed.

In this configuration, the image of the selected image data may be displayed in the display region A1. When the image of the selected image data is displayed in the display region A1, the size of the display region A1 is set to be greater than the size illustrated in FIG. 10.

When the size of the display region A1 is changed, information indicating the size of the display region A1 may be transmitted from the information processing apparatus 20 to the projector 10. The projector 10 may generate data of the GUI image fitted to the transmitted size and transmit the data to the information processing apparatus 20. Then, the information processing apparatus 20 may display the image of the GUI in the display region A2 based on the data of the transmitted GUI image.

In the invention, when power is turned on after establishment of the connection with the information processing apparatus 20, the projector 10 may turn off power in a case in which the connection is cut. When the network standby is set to be valid and the connection with the information processing apparatus 20 is established, the projector 10 may turn on power.

In the above-described embodiments, when the projector 10 transmits the function information to the information processing apparatus 20, the projector 10 may include the setting state of the network standby function and the information processing apparatus 20 may display ON/OFF of the check box according to the setting state of the network standby function included in the function information when the dialog box of FIG. 9 is displayed.

In the invention, when the connection is established between the information processing apparatus 20 and the projector 10 of which the power is turned on and the information processing apparatus 20 displays the screen of FIG. 10, the information processing apparatus 20 may display the screen of FIG. 7 in response to cutting of the connection in a case in which the projector 10 is turned off by the operation unit 130 or the remote controller.

In the above-described embodiments, when the image quality is set in the dialog format, the video to be viewed is selected, the viewing environment is subsequently selected, the hue is subsequently selected, and the sense of sharpness is subsequently selected. Then, the video processing unit 150 is controlled and the image quality is changed in each selection step. However, the invention is not limited to this configuration. For example, after the video to be viewed, the viewing environment, the hue, and the sense of sharpness are all selected, the video processing unit 150 may be controlled and the image quality is changed in the selected small order.

The color mode set according to the viewing environment may be set to be different between the case in which the video signal is a 2D image and the case in which the video signal is a 3D image. Specifically, the control unit 110 determines whether a video signal indicating an image to be projected is a signal of the 2D image or a signal of the 3D image. For example, in a case in which the signal of the image to be projected is the signal of the 2D image, the control unit 110 sets the color mode to “bright cinema” when the user selects “bright” as the viewing environment. The control unit 110 sets the color mode to “cinema” when the user select “dark” as the viewing environment. In a case in which the signal of the image to be projected is the signal of the 3D image, the control unit 110 sets the color mode to “3D dynamic” when the user selects “bright” as the viewing environment. The control unit 110 sets the color mode to “3D cinema” when the user select “dark” as the viewing environment.

In the invention, in a case in which the projector 10 projects an image of image data transmitted via a wireless LAN, items of the image quality setting performed in the dialog format may be different items from the above-described embodiments. For example, first, the projection surface of a video is configured to be selected from “screen”, “white board”, and “black board” in the first step. Here, in a case in which “screen” is selected, brightness of a screen to be projected is set to first brightness decided in advance. In a case in which “white board” is selected, brightness of a screen to be projected is set to second brightness decided in advance. In a case in which “black board” is selected, the color mode is set to a mode decided in advance.

In a subsequent step, content of the video to be projected is configured to be selected from “business document”, “photo”, and “web page”. Here, in a case in which “business document” is selected, the color mode is set to “presentation” and the sharpness is set to a setting value decided in advance. In a case in which “photo” is selected, the color mode is set to “dynamic”. In a case in which “web page” is selected, the color mode is set to “dynamic” and the sharpness is set to a setting value decided in advance.

In the embodiment, a previous operation history may be stored when the image quality is set in the dialog format and the order of the items displayed on the screens of FIGS. 18 to 21 may be changed based on the stored operation history. For example, display positions of selected items may be displayed to be arranged in the descending order according to the number of times the items are previously selected on each screen.

In the above-described embodiments, the apparatus projecting an image is a liquid crystal projector using a transmissive liquid crystal panel, but may be a projector using a reflective liquid crystal panel or a digital mirror device. In the above-described embodiments, the apparatus receiving the image data transmitted from the information processing apparatus 20 and displaying the image is not limited to the projector 10. For example, a direct-view display apparatus such as a liquid crystal television may be used.

In the above-described embodiments, the communication performed between the projector 10 and the information processing apparatus 20 is the wireless communication in conformity to the IEEE 802.11 standard, but may be communication in conformity to Bluetooth (registered trademark), communication by an infrared ray, or communication in conformity to another wireless communication standard.

The controller application may be configured to include a table in which a model name of the projector 10 matches a function of the model name. In the case of this configuration, the information processing apparatus 20 may acquire the model name from the projector 10 establishing the connection and specify the function of the connection destination projector 10 from the table and the acquired model name.

A program realizing a function according to the invention may be provided in a state in which the program is stored in a computer-readable recording medium such as a magnetic recording medium (a magnetic tape, a magnetic disk (a hard disk drive (HDD), a flexible disk (FD), or the like)), an optical recording medium (an optical disc or the like), a magneto-optical recording medium, or a semiconductor memory, and may be installed on each apparatus. The program may be downloaded via a communication network and may be installed on each apparatus.

What is claimed is:

1. An information processing apparatus comprising:
a communication section that is connected to a display apparatus to perform communication;
a display section that displays an operation screen for operating the display apparatus;
a function information reception section that receives function information indicating a function of the display apparatus from the display apparatus through the communication section;
an operation screen information reception section that receives operation screen information for operating the display apparatus from the display apparatus through the communication section;
a storage section that stores common operation screen information for operating the display apparatus; and
a display control section that causes the display section to display an operation screen according to the operation screen information received by the operation screen information reception section in a case in which the function information includes a function of supplying the operation screen information, and causes the display section to display an operation screen according to first common operation screen information stored in the storage section in a case in which the function information includes no function of supplying the operation screen information.

2. The information processing apparatus according to claim 1,
wherein the display control section further displays an operation screen based on second common operation screen information which is stored by the storage section and is information for an operation common to a plurality of display apparatuses in the case in which the function information includes the function of supplying the operation screen information.

3. The information processing apparatus according to claim 2,
wherein the second common operation screen information includes information regarding an operation of changing a connection destination of the communication section.

4. The information processing apparatus according to claim 2,
wherein the second common operation screen information includes information regarding an operation of changing content displayed by the display apparatus to which the communication section is connected.

5. The information processing apparatus according to claim 2,
wherein the operation screen information reception section receives operation screen information with a size according to a size of an operation screen displayed based on the second common operation screen information.

6. An operation screen display method comprising:
receiving function information indicating a function of a display apparatus from the display apparatus to which a communication section connected to the display apparatus to perform communication is connected; and
causing a display section to display an operation screen according to operation screen information acquired from the display apparatus to which the communication section is connected in a case in which the function information includes a function of supplying the operation screen information for operating the display apparatus, and causing the display section to display an operation screen according to first common operation screen information stored in advance to operate the display apparatus in a case in which the function information includes no function of supplying the operation screen.

7. A computer-readable recording medium storing a program, the program causing a computer to function as:
a communication section that is connected to a display apparatus to perform communication;
a display section that displays an operation screen for operating the display apparatus;
a function information reception section that receives function information indicating a function of the display apparatus from the display apparatus through the communication section;
an operation screen information reception section that receives operation screen information for operating the display apparatus from the display apparatus through the communication section;
a storage section that stores common operation screen information for operating the display apparatus; and
a display control section that causes the display section to display an operation screen according to the operation screen information received by the operation screen information reception section in a case in which the function information includes a function of supplying the operation screen information, and causes the display section to display an operation screen according to first common operation screen information stored in the storage section in a case in which the function information includes no function of supplying the operation screen information.
